(19) United States
(12) Patent Application Publication
(10) Pub. No.: US 2010/0278156 A1
(43) Pub. Date: Nov. 4, 2010

(54) DATA COMMUNICATION METHOD USING BODY AREA NETWORK SUPERFRAME

(76) Inventors: Chang Sub Shin, Daejeon (KR); Wun Cheol Jeong, Daejeon (KR); Seong Soon Joo, Daejeon (KR); Jong Suk Chae, Daejeon (KR); Myung Jong Lee, New York, NY (US); June Seung Yoon, New York, NY (US); Gahng Seop Ahn, New York, NY (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/773,646

(22) Filed: May 4, 2010

(30) Foreign Application Priority Data
May 4, 2009 (KR) 10-2009-0039022
Apr. 29, 2010 (KR) 10-2010-0039964

(51) Int. Cl. H04B 7/212; H04W 4/00

(52) U.S. Cl. 370/337; 370/328

(57) ABSTRACT

There is provided a data communication method using a body area network superframe including an advertisement period, a contention medium access period, a beacon period, and a data transmit period, the data communication method including: broadcasting, by a coordinator node, predetermined information during the advertisement period; transmitting, by nodes, which wish to transmit data, the data only when carrier is not in use as a result of sensing the carrier after the contention medium access period is initiated and a predetermined backoff time elapses; broadcasting, by each of the nodes, periodic beacon signals during the beacon period; and transmitting, by each of the nodes, continuous data and periodic data during the data transmit period

### CROSS-REFERENCE TO RELATED APPLICATIONS

This application claims the priorities of Korean Patent Application Nos. 10-2009-0039022 filed on May 4, 2009 and 10-2010-0039964 filed on Apr. 29, 2010, in the Korean Intellectual Property Office, the disclosures of which are incorporated herein by reference.

### BACKGROUND OF THE INVENTION

1. Field of the Invention

The present invention relates to a data communication method using a body area network superframe, and more particularly, to a technology capable of transmitting various types of data while maintaining the quality thereof and reducing energy consumption by executing data communication using a body area network (BAN) superframe that is configured to include an advertisement period, a contention access period (CAP), a beacon, a data transmit period (DTP), and an inactive period.

2. Description of the Related Art

In general, commercial wireless communications devices share the same radio frequency band, such that the interfering signals are generated between wireless communications devices. Interfering signals are one of the main causes for the deterioration of the quality of received signals and further serve to degrade the performance of wireless communication systems.

Radio interfering signals may be classified into self-interfering signals, caused by a wireless device performing the same kind of applications, and mutual interfering signals, caused by different kinds of wireless devices using the same radio frequency band.

Self-interfering signals may be solved by a medium access control (MAC) scheme such as a frequency division scheme, a time division scheme, a code division scheme, and the like, all of which mainly use the orthogonality of the signal. The problem of mutual interfering signals, or contention between the wireless devices, may be solved by using the same medium access control (MAC) scheme for the wireless devices.

The MAC scheme that has been most widely used in the wireless network is a carrier sense multiple access/collision detect (CSMA/CD) scheme that senses carriers and preemptively prevents collisions therebetween. There is a disadvantage in that the MAC scheme cannot guarantee a transmission band.

As for another scheme, there is a time division multiple access (TDMA) scheme that performs a control using the allocation of reservation time between devices that share radio transmission links. There is a disadvantage in that the TDMA delays transmission until an allocated time slot becomes available.

In executing data communication using the body area network (BAN) , there is a need to receive various kinds of data in consideration of priority, burst, period, and continuity of traffic, such as an emergency vital sign that is an emergency alarm, EEG/ECG/EMG that are data sensitive to time delay, information such as body temperature and blood pressure, that is, general medical information, which demands transmission reliability in data rather than a delay in data transmission, and streaming data such as video and audio, and so on.

### SUMMARY OF THE INVENTION

An aspect of the present invention provides a data communication method using a body area network superframe capable of transmitting various types of data while maintaining the quality thereof and reducing energy consumption by executing data communication using the body area network superframe that is configured so as to include an advertisement period, a contention access period, a beacon, a data transmit period (DTP), and an inactive period.

According to an aspect of the present invention, there is provided a data communication method using a body area network superframe including an advertisement period, a contention medium access period, a beacon period, and a data transmit period, including: broadcasting, by a coordinator node, predeter ined information during the advertisement period; transmitting, by nodes, which wish to transmit data, the data only when carrier is not in use as a result of sensing the carrier after the contention medium access period is initiated and a predetermined backoff time elapses; broadcasting, by each of the nodes, periodic beacon signals during the beacon period; and transmitting, by each of the nodes, continuous data and periodic data during the data transmit period.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram showing architecture of a body area network superframe according to an exemplary embodiment of the present invention; and

FIGS. 2A through 2E are diagrams showing various embodiments executing communications using a body area network superframe according to an exemplary embodiment of the present invention.

### DETAILED DESCRIPTION OF THE PREFERRED EMBODIMENT

Exemplary embodiments will now be described in detail with reference to the accompanying drawings so that they can be easily practiced by a person skilled in the art to which the present invention pertains. However, in describing the exemplary embodiments of the present invention, detailed descriptions of well-known functions or constructions are omitted so as not to obscure the description of the present invention with unnecessary detail. In addition, like reference numerals denote parts performing similar functions and actions throughout the drawings.

Throughout this specification, when it is described that an element is “connected” to another element, the element may be “directly connected” to another element or “indirectly connected” to another element through a third element. In addition, unless explicitly described otherwise, “comprising” any components will be understood to imply the inclusion of other components but not the exclusion of any other components.

The present invention relates to architecture of a superframe used in a body area network (BAN) and a data communication method using the same. The BAN signifies a communication network that transmits data to the interior body and the body area as transmission targets.

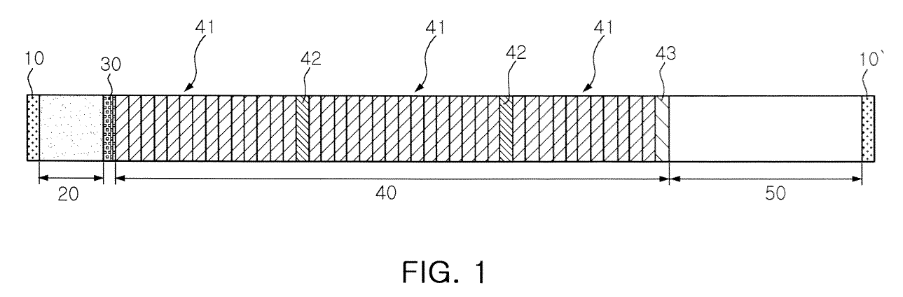

FIG. 1 is a diagram showing architecture of a body area network superframe according to an exemplary embodiment of the present invention. The BAN superframe is configured to include an advertisement period 10, a contention access period (CAP) 20, a beacon 30, a data transmit period (DTP) 40, and an inactive period 50.

The advertisement period 10 is a period that a BAN coordinator (BC) broadcasts information including at least one of synchronization information maintained by the BC, an address of the BC, a length of the CAP 20, and an advertisement interval

(AI). At this time, the advertisement interval signifies an interval from the advertisement period 10 of one superframe to an advertisement period 10′ of the next superframe. Nodes accessing the body area network for the first time use information broadcast by the BC during the advertisement period 10 in order to control clocks and acquire information on the BC and a BAN-SB therefrom.

A general beacon-based superframe according to the related art has architecture having ‘beacon/contention medium access period/time slot’. All of the nodes acquire synchronization and network information by receiving beacon signals and then, transmit and receive data based on the acquired information. However, in order to provide services using the body communication, a need exists for a new apparatus capable of immediately transmitting data while quickly accessing the network. In this case, the related art can transmit and receive data only after listening to the beacon signals, requesting access during the contention medium access period, and listening to the next beacon signals, thereby generating the minimum delay time corresponding to the length of the superframe. On the other hand, the present invention requests access and slot allocation during the contention medium access period 20, immediately after acquiring information during the advertisement period 10, and can normally transmit and receive data during the subsequent data transmit period 40. That is, the present invention positions the advertisement period 10 at the head of the superframe in order to satisfy the above-mentioned requirements.

The contention medium access period 20 is a period operated in such a manner nodes, which wish to transmit data, among nodes belonging to the body area network, wait for a predetermined backoff time in order to avoid inter-node collision at the time of transmitting data and then sense carrier energy, and attempt to transmit data when carrier is not in use.

At this time, the nodes set the backoff time differently, according to the priority ranking of data to be transmitted by each node, such that they may be controlled to first transmit data having higher priority.

Further, data transmitted during the contention medium access period 20 may include a command frame exchanged so as to occupy the data transmit slot at the data transmit period 40, non-periodic data such as an alarm, data to be retransmitted due to transmission failure at the data transmit slot, and the like.

The beacon 30 is a period transmitting periodic communication signals that transmit the main information of the network. The beacon can provide the frame synchronization, the interval of the beacon, the length of the data transmit period 40, information regarding the state of occupied slots within the data transmit period 40, and the like. The beacon is broadcast to all the nodes belonging to the network before the data transmit period 40 and the nodes occupying the data transmit slot modify the state of occupied slots according to the state information of occupied slots within the beacon for each advertisement interval.

The data transmit period 40 is operated according to the TDMA scheme and is a period that is used to transmit periodic data and continuous data sensitive to delay. The data transmit period 40 is divided into slots, each having a predetermined time size. That is, the data transmit period 40 may be divided into the data transmit slot (DTS) 41 and the emergency transmit slot (ETS) 42.

The data transmit slot 41 is previously allocated to transmit the periodic data and is subsequently used therefor.

The data transmit slot 41 maybe allocated according to the data priority ranking. That is, the data transmit slot 41 may be preferentially allocated to a higher priority ranking.

The emergency transmit slot 42 is acquired by the contention between the nodes and is then used to transmit the emergency data or the general data. After it is determined as to whether other nodes are using the emergency transmit slot 42 by sensing the carrier, the emergency transmit slot 42 transmits the emergency data or the general data when there are no emergency data to prevent inter-data collision. The nodes necessary for the emergency data transmission can transmit the emergency data during the emergency transmit slot 42 that is periodically repeated during the data transmit period 40. When the data transmit period 40 includes only the general data transmit slot 41, it waits for its own allocation slot and then transmits data. On the other hand, the present invention can transmit data at the emergency transmit slot 42 when there is a need to immediately transmit the emergency data, thereby making it possible to minimize the transmission delay time.

Further, the final slot 43 of the data transmit period 40 may be allocated to transmit a batch ACK for transmission within the data transmit period 40. In addition, when transmitting data using a continuous multi-slot from the same source at the data transmit period 40, a next slot of the multi-slot may be used for a delayed ACK.

Finally, the inactive period 50 is a period in which data is not transmitted in order to minimize energy consumption at the nodes. However, when energy is sufficiently supplied to the BC, the BC may use the inactive period 50 as an extended CAP (ECAP). In this case, all kinds of data can be transmitted.

According to the present invention, the data priority ranking of the body area network is divided into five rankings. For example, ranking 0 is an emergency alarm, which may be allocated to information such as the emergency vital sign, ₜhe battery discharge, and the like. Ranking 1 may be allocated to information such as data sensitive to time delay, EEG/ECG/EMG, and the like, among medical information. Ranking 2 is for general medical information, which may be allocated to information, such as body temperature and blood pressure, which demands data transmission reliability, rather than data transmission delay. Ranking 3 may be allocated to non-medical continuous data such as video and audio. Finally, ranking 4 may be allocated to other general data. The data priority ranking may be variously allocated according to the kind of data and the required conditions.

The allocated data priority ranking may be applied in a processing sequence at the time of transmitting data. Further, the nodes transmitting data having higher priority execute the carrier sensing and the backoff shorter than the existing slot occupying nodes at the emergency transmit slot, thereby making it possible to preferentially occupy the emergency transmit slot.

Further, in order to minimize the energy consumption, the BAN coordinator and each node may be maintained in an inactive state. For example, the BAN coordinator may be maintained in an inactive state when it does not perform other activities after the contention medium access period or the data transmit period. Further, the node transmitting the continuous data may be maintained in the inactive state when the occupation of the data transmit slot is completed, except for the beacon and the occupied time slot. Further, the node transmitting the general data may be in the active state in order to make the report only at the first arriving contention medium access period or extended contention medium access period and the node transmitting the alarm may be in the active state in order to make the report only at the first arriving period of the contention medium access period, the emergency transmit slot, and the extended contention medium access period.

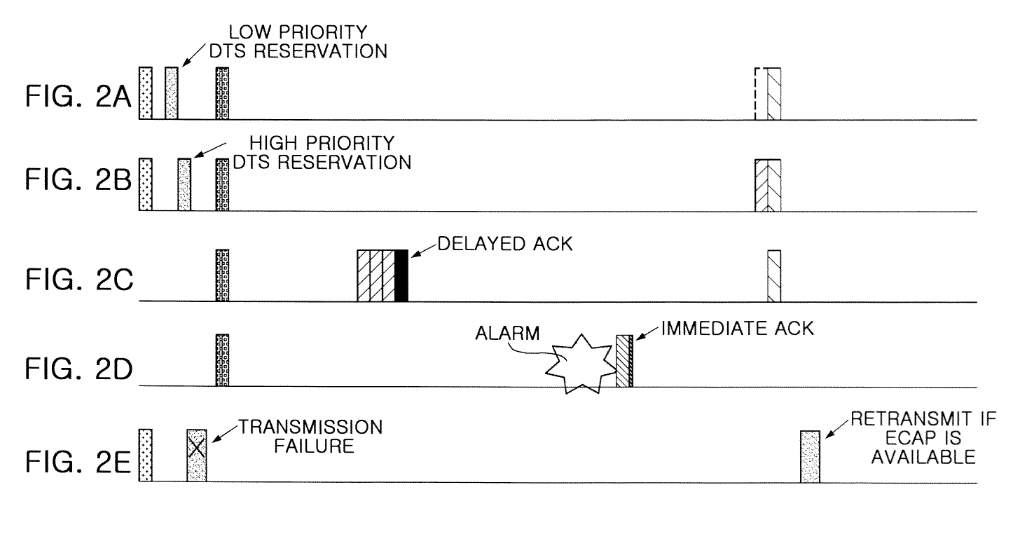

FIGS. 2A through 2E are diagrams showing various embodiments of executing communications using a body area network superframe according to an exemplary embodiment of the present invention.

FIGS. 2A and 2B show the data transmit slot differences between nodes having different data priority rankings. It can be appreciated from FIGS. 2A and 2B that nodes having a higher priority ranking preferentially occupy the data transmit slot.

Further, FIG. 2C shows an example of using the immediately subsequent slot for the delayed ACK when transmitting data using the continuous multi-slot.

In addition, FIG. 2D shows an example of transmitting immediate ACK after transmitting the alarm data using the emergency transmit slot.

Further, FIG. 2E shows an example of retransmitting data, which failed to be transmitted during the contention medium access period, at the extended contention medium access period.

As set forth above, according to exemplary embodiments of the present invention, the data communication method using the body area network super frame shares the limited link resources, thereby making it possible to transmit data with good quality and reduce the energy consumption of the node.

While the present invention has been shown and described in connection with the exemplary embodiments, it will be apparent to those skilled in the art that modifications and variations can be made without departing from the spirit and scope of the invention as defined by the appended claims.

What is claimed is:

1. A data communication method using a body area network superframe including an advertisement period, a contention medium access period, a beacon period, and a data a transmit period, comprising:
broadcasting, by a coordinator node, predetermined information during the advertisement period;
transmitting, by nodes, which wish to transmit data, the data only when carrier is not in use as a result of sensing the carrier after the contention medium access period is initiated and a predetermined backoff time elapses;
broadcasting, by each of the nodes, periodic beacon signals during the beacon period; and
transmitting, by each of the nodes, continuous data and periodic data during the data transmit period.

2. The data communication method using a body area network superframe of claim 1, wherein the predetermined information includes at least one of synchronization information maintained by the coordinator node, an address of the coordinator node, a length of the contention medium access period, and an advertisement interval.

3. The data communication method using a body area network superframe of claim 1, wherein the backoff time is differently set according to the priority ranking of the data.

4. The data communication method using a body area network superframe of claim 1, wherein the data transmittable at the contention medium access period includes a command frame exchanged to occupy the data transmit slot, non-periodic data, and data to be retransmitted due to transmission failure.

5. The data communication method using a body area network superframe of claim 1, wherein the data transmit period is operated according to a time division multiple access (TDMA) scheme.

6. The data communication method using a body area network superframe of claim 5, wherein the data transmit period is divided into a slot having a predetermined time size and the slot is divided into a data transmit slot and an emergency transmit slot.

7. The data communication method using a body area network superframe of claim 6, wherein the data transmit slot is allocated to each of the nodes according to the priority ranking of the data in order to transmit the periodic data.

8. The data communication method using a body area network superframe of claim 6, wherein the emergency transmit slot is allocated to any node by the inter-node contention.

9. The data communication method using a body area network superframe of claim 6, wherein the final slot of the data transmit period is allocated in order to transmit a batch ACK.

10. The data communication method using a body area network superframe of claim 6, wherein a slot immediately after multi-slot transmitting the continuous data at the slot in the data transmit period is allocated in order to transmit the delayed ACK.

11. The data communication method using a body area network superframe of claim 1, wherein the superframe further includes an inactive period that is not operated in order to save energy, and
the coordinator node uses the inactive period as an extended contention medium access period when the supplied energy exceeds the predetermined reference.
